(19) United States
(12) Patent Application Publication
(10) Pub. No.: US 2013/0306672 A1
(43) Pub. Date: Nov. 21, 2013

(54) Dispensing Apparatus

(71) Applicant: Mark White, Sheffield (GB)

(72) Inventor: Mark White, Sheffield (GB)

(73) Assignee: Milko (Yorkshire) Limited, Leeds (GB)

(21) Appl. No.: 13/541,053

(22) Filed: Jul. 3, 2012

(30) Foreign Application Priority Data
May 15, 2012 (GB) GB1208549.4

(51) Int. Cl. B67D 7/14

(52) U.S. Cl. 222/63

(57) ABSTRACT

A dispensing apparatus for dispensing a controlled amount of powder, the apparatus comprising a hopper defining an exit aperture; an Archimedes screw rotatably supported in the hopper and configured to expel powder from the exit aperture; an actuator configured to rotate the Archimedes screw; a cover configured to selectively close the exit aperture; and a clutch arrangement between the cover and the Archimedes screw. Movement of the cover is controlled by the Archimedes screw through the clutch arrangement.

### CROSS-REFERENCE TO RELATED APPLICATIONS

This application claims priority for Application GB1208549.4 filed on May 15, 2012 in the United Kingdom.

### FIELD OF THE INVENTION

The present invention relates to a dispensing apparatus.

### BACKGROUND OF THE INVENTION

It is known to mix powder and liquid to produce a solution. In particular, it is known to mix powder and liquid to produce a drinkable solution, such as baby milk formula. To mix such a solution the amounts of powder and liquid used must be measured to ensure that the correct solution is produced. Accurate measurements are required, particularly in the case of baby formula.

It can be difficult to achieve accurate measurements of powder and liquid. Baby milk formula powder, for example, is very light, and so is difficult to measure correctly. It is also difficult to mix formula whilst holding or otherwise looking after a baby, especially to the required level of accuracy.

It is known to use dispensers to measure out and mix powder and liquid such as baby formula. Such dispensers usually have a powder dispenser and a liquid dispenser, and allow relatively accurate production of solutions. However, there are difficulties with such dispensers, and they can be expensive. The internal components can be difficult to access for cleaning. Keeping powder in a dispenser prior to dispensing can lead to powder becoming moist, and so prone to bacterial growth and difficult to dispense accurately. Accurate measuring of powder can be difficult to achieve and time consuming, especially where methods such as load cells are used. The provision of a load cell adds to the cost of a dispenser.

It is advised that baby formula powder should be mixed with liquid that is at at least 70° C., so that the powder is safe for consumption. However, 70° C. is too hot for drinking, so the mixture must be cooled to a suitable temperature before being offered to a baby, resulting in a significant delay between mixing and feeding which can be inconvenient.

The present invention seeks to overcome or at least mitigate the problems of the prior art.

### SUMMARY OF THE INVENTION

According to the present invention there is provided a dispensing apparatus for dispensing a controlled amount of powder, the apparatus comprising a hopper defining an exit aperture; an Archimedes screw rotatably supported in the hopper and configured to expel powder from the exit aperture; an actuator configured to rotate the Archimedes screw; a cover configured to selectively close the exit aperture; and a clutch arrangement between the cover and the Archimedes screw. Movement of the cover is controlled by the Archimedes screw through the clutch arrangement.

The clutch arrangement allows the cover to be automatically closed following dispensing, so that powder held within the dispenser is kept dry and clean when the dispenser is not in use. Controlling movement of the cover through the Archimedes screw provides simple cover operation using existing components.

There is also provided a dispensing apparatus for dispensing a controlled amount of powder, the apparatus comprising a hopper defining an exit aperture; an Archimedes screw rotatably supported in the hopper and configured to expel powder from the exit aperture; an actuator configured to rotate the Archimedes screw; and a detection arrangement configured to determine loading of the Archimedes screw.

Detection of loading of the Archimedes screw allows calculation of the amount of powder in the hopper, as the more powder there is, the more loading on the screw there will be. The dispensing apparatus can thus advantageously provide an indication of when refilling of the hopper is required.

There is further provided a dispensing apparatus for dispensing a controlled volume of liquid, the apparatus comprising a liquid supply; a heater in fluid communication with the supply; a transfer arrangement for transferring liquid from the supply, and a control system configured to control the liquid temperature. The control system is configured to dispense a first volume of liquid at a first, higher than ambient temperature and a second volume of liquid at a second temperature lower than the first temperature, through selective operation of the transfer arrangement and/or the heater.

The dispensing apparatus can, through the control of the volume and temperature of liquid dispensed, enable liquid to reach powder at a temperature high enough to render the powder safe for consumption, and ensure that the resulting mixture is at a suitable drinking temperature to minimise delay before drinking.

There is yet further provided a dispensing apparatus for dispensing a controlled amount of powder, the apparatus comprising: a hopper defining an exit aperture; an Archimedes screw rotatably supported in the hopper and configured to expel powder from the exit aperture; and an actuator configured to rotate the Archimedes screw. The Archimedes screw is detachably engaged with the actuator, such that the Archimedes screw may be removed from the apparatus without adjustment of the actuator.

The hopper may be removable from the apparatus, and/or the Archimedes screw may be configured for engagement with the actuator external to the hopper. The Archimedes screw may include a gear configured for engagement with the actuator, and/or a shaft of the Archimedes screw may extend external to the hopper, and the gear may be located on the shaft outside the hopper.

The detachable nature of the Archimedes screw allows removal of the screw from the apparatus for cleaning or replacement purposes.

There is further provided a dispensing apparatus for dispensing a controlled amount of powder, the apparatus comprising a hopper defining an exit aperture, an Archimedes screw rotatably supported in the hopper and configured to expel powder from the exit aperture; a first actuator configured to rotate the Archimedes screw; a cover configured to selectively close the exit aperture; and a second actuator configured to operate the cover. The second actuator is an electromechanical actuator, and may be a solenoid.

The second actuator provides automatic closing of the cover, so that powder held within the dispenser is kept dry and clean when the dispenser is not in use.

There is also provided a method of producing a powder and liquid solution comprising the steps of:

a) providing a dispensing apparatus configured to dispense a controlled amount of powder and a controlled volume of liquid;

b) concurrently dispensing a controlled volume of powder and a controlled volume of liquid at a first, higher than ambient temperature;

c) dispensing a controlled volume of liquid at a second temperature lower than the first temperature.

Step b) may take place prior to step c).

Such a method enables liquid to reach the powder at a temperature high enough to render the powder safe for consumption, and ensure that the resulting mixture is at a suitable drinking temperature to minimise delay before drinking.

Preferred embodiments of the invention are provided by the dependent claims.

### BRIEF DESCRIPTION OF THE DRAWINGS

Other aspects and preferred features of the invention will be readily apparent from the claims and following description of preferred embodiments made, by way of example only, with reference to the following drawings, in which:

FIG. 1 is a front view of a dispensing apparatus according to an embodiment of the present invention;

FIG. 2 is a cross-sectional view through the dispensing apparatus of FIG. 1 along the axis A-A;

FIG. 3 is a front view of a powder dispensing apparatus of the dispensing apparatus of the embodiment of FIGS. 1 and 2;

FIG. 4 is a cross-sectional view through the powder dispensing apparatus of FIG. 3 along the axis B-B;

FIG. 5 is an exploded view of the powder dispensing apparatus of FIGS. 3 and 4; and

FIG. 6 is a cross-sectional view through a dispensing apparatus according to a second embodiment of the present invention.

### DETAILED DESCRIPTION OF THE PREFERRED EMBODIMENTS

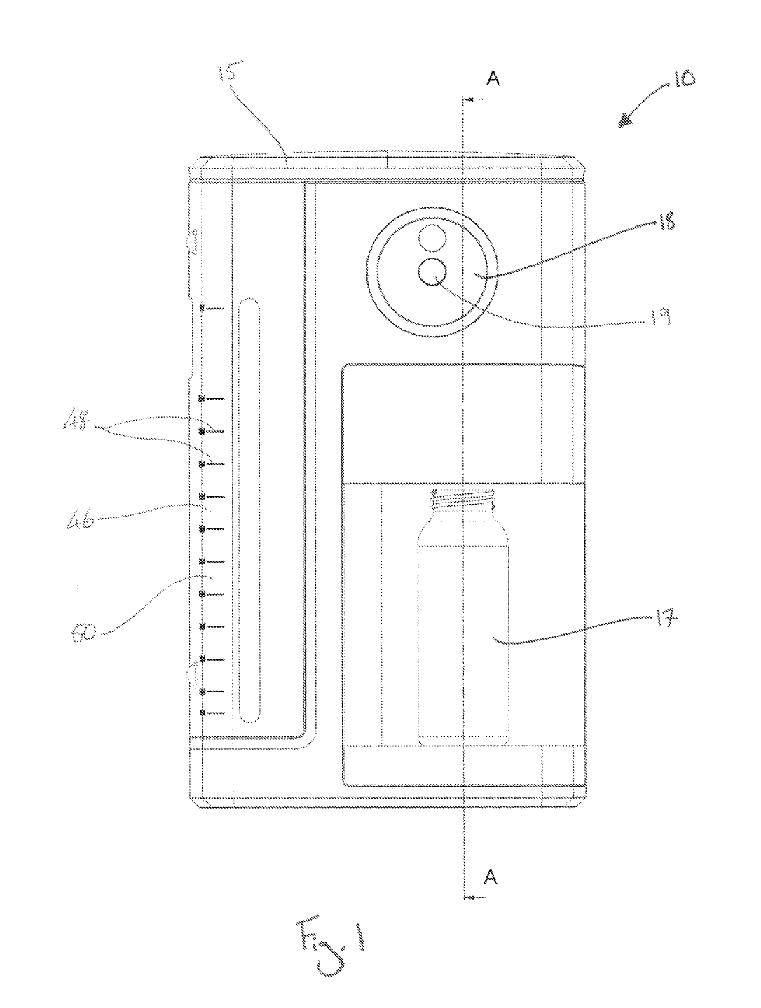

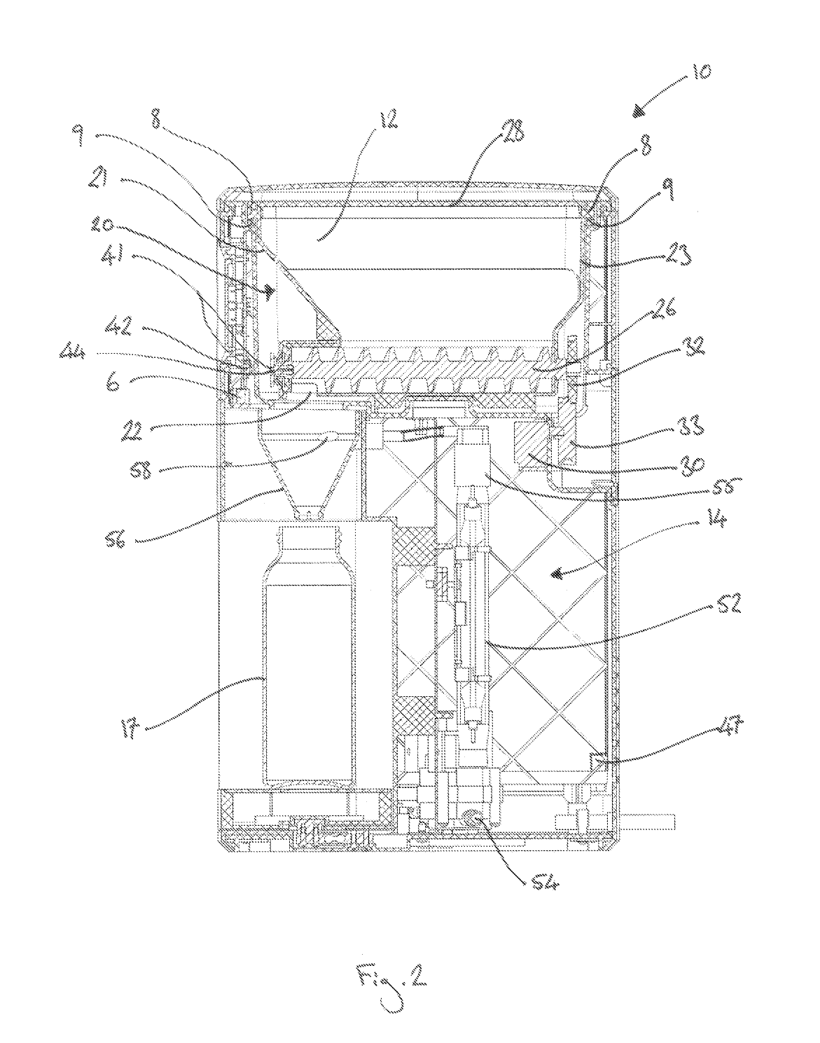

With reference to FIGS. 1 and 2, a dispensing apparatus for dispensing controlled amounts of powder and liquid is generally indicated at 10. As shown in FIG. 2, the dispensing apparatus 10 includes a powder dispensing apparatus 12 and a liquid dispensing apparatus 14 within a housing 16 having a lid 15. The powder dispensing apparatus 12 and liquid dispensing apparatus 14 are controlled by a control system 6 (such as a suitable microprocessor controller having associated memory to store machine settings) to dispense a required amount of powder and liquid (e.g. baby formula and water) into a baby feeding bottle 17. A selector 18 on the outside of the housing 16, movable between a plurality of positions, determines the quantity of powder and liquid dispensed. An on/off switch 19 for the dispensing apparatus 10 is provided on the selector 18.

The powder dispensing apparatus 12 comprises a hopper 20 for storing powder. The hopper 20 has opposing end walls 21, 23. In this embodiment, each wall 21, 23 has a cylindrical projection 8 extending externally of the hopper 20. The projections 8 are configured to sit in corresponding apertures 9 in the housing 16, to retain the hopper 20 relatively accurately in position. A lower end 24 of the hopper 20 is partially cylindrical, with a longitudinal axis that is substantially horizontal in use. The hopper 20 defines an exit aperture 22 in the lower end 24 where the lower end 24 extends beyond one of the end walls 21. The hopper 20 has an open upper end 25 through which the hopper 20 can be filled with powder. The upper end 25 is wider than the lower end 24, and the hopper 20 has sloping sides 27 extending between the upper and lower ends 24, 25. Powder placed in the hopper 20 is funnelled down to the lower end 24 by the sloping sides 27, and dispensed from the exit aperture 22 into a mixing funnel 56 which leads to the bottle 17.

The hopper 20 has a substantially airtight lid 28 (see FIG. 2) that is used to selectively close the upper end 25 of the hopper 20. The lid 28 is removed from the hopper 20 so that the hopper 20 can be filled with powder, then is replaced to protect the powder within the hopper 20. The hopper 20 and the lid 28 are in this embodiment of suitable plastics material such as polypropylene.

An Archimedes screw 26 is rotatably supported in the lower end 24 of the hopper 20. The screw 26 has a shaft 29 supported by a bearing 31 in the end wall 23. The screw 26 extends over the exit aperture 22 and is configured to expel powder therefrom upon rotation of the screw 26 in a first direction. In this embodiment the Archimedes screw 26 is positioned such that its longitudinal axis is coincident to that of the lower end 24, so that in use the longitudinal axis of the Archimedes screw 26 extends substantially horizontally. The shaft 29 has a first end 29a proximate the exit aperture 22 and a second end 29b extending through one of the end walls 23. In alternative embodiments (not shown) the screw 26 may be substantially vertical in use, or may be inclined at an angle between the horizontal and the vertical. The hopper 20 may be adapted accordingly.

The powder dispensing apparatus 12 further comprises an actuator for operation of the screw 26 in the form of a stepper motor 30. In alternative embodiments of the invention other suitable types of motor or other types of actuator may be used.

A bevel gear 32 supported by the second end 29b of the shaft 29 outside the hopper 20 is configured to rotate with the shaft 29. The motor 30 is located outside the hopper 20 proximate the end wall 23. The gear 32 is configured for driving engagement with the motor 30 through a second bevel gear 33, so that, in use, the motor 30 turns the shaft 29 and thus the screw 26 through the gear 32. In alternative embodiments other types of gear may be used, e.g. straight toothed gears or a pulley arrangement.

In this embodiment, the gear 32 is positioned, in use, above the motor 30. The hopper 20 and the screw 26 can therefore be lifted away from the motor 30 and second gear 33 and removed from the powder dispensing apparatus 12 without affecting the motor 30. The hopper 20 and the screw 26 can thus easily be removed for the purpose of cleaning or replacement without risk of damage to delicate components such as the motor 30.

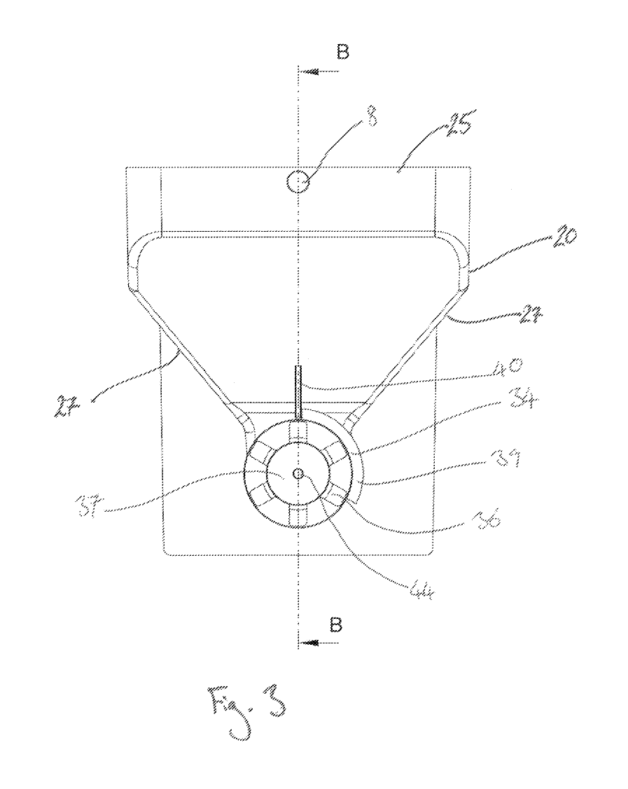

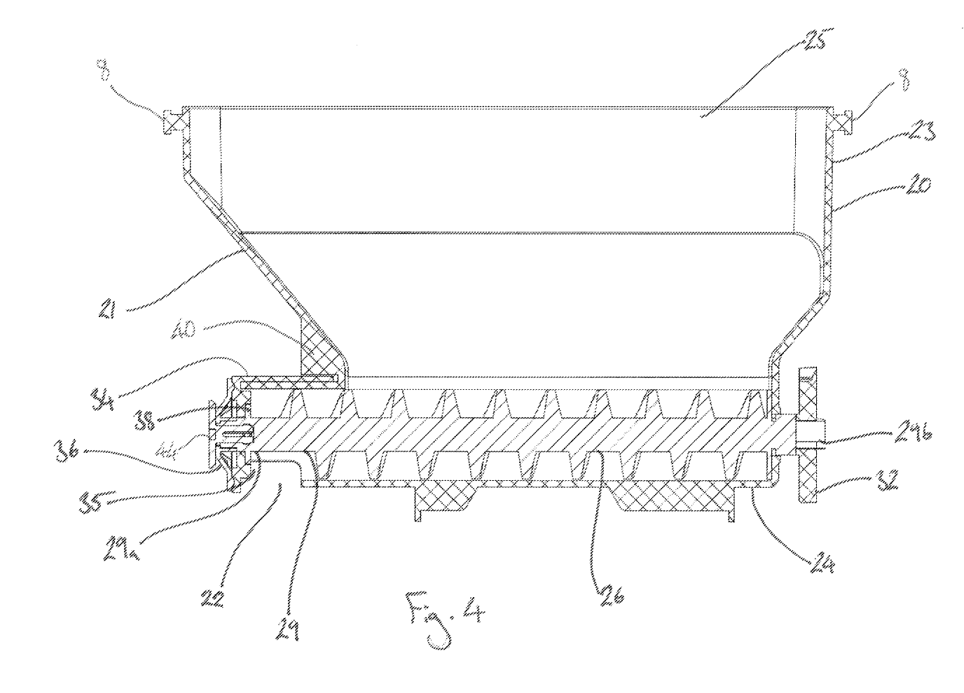

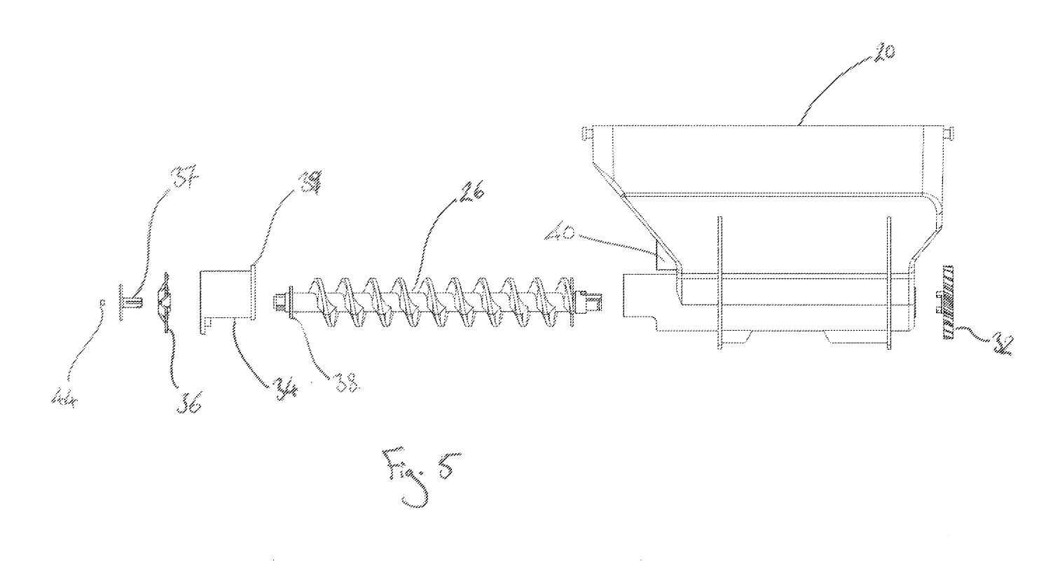

In order to keep powder held within the hopper 20 dry and fresh, a cover 34 is provided for the exit aperture 22 (see FIGS. 3, 4 and 5). The cover 34 comprises a part cylinder closed at one end that is fitted over the first end 29a of the shaft 29 such that the cover 34 can rotate independently of the shaft 29 between a first position and a second position. The cover 34 defines a substantially rectangular aperture 35 in its cylindrical wall. When the cover 34 is in a first position the cover aperture 35 is away from the exit aperture 22, so the exit aperture 22 is closed by the cylindrical wall, and powder is prevented from exiting the hopper 20. When the cover 34 is in a second position, the aperture 35 is aligned with the exit aperture 22, and powder can exit the hopper 20 through the exit aperture 22.

A conical spring 36 keyed to the first end 29a of the shaft biases the cover 34 against a shoulder 38 of the shaft 29, and so retains the cover 34 on the shaft 29. The spring 36 is retained on the shaft 29 by a push fit clip 37 that extends into a bore in the first end 29a. Despite the cover 34 being rotatable in relation to the shaft 29, the spring 36 acting on the cover 34 creates a frictional force between the cover 34 and the shaft 29, so that the cover 34 rotates with the shaft 29 when there is no impediment to the cover 34 doing so. In alternative embodiments some biasing mechanism other than a conical spring may be used, and the spring or other biasing mechanism may not be keyed to the shaft 29.

The cover 34 comprises a lip 39 extending partway around its perimeter. When the cover 34 is rotated in the first direction by rotation of the shaft 29 to the second position, the lip 38 comes into contact with a fin 40 extending from the hopper 20 for that purpose, and the cover 34 is prevented from further rotation even if the shaft 29 continues to rotate, and slips in relation to the shaft 29, overcoming the friction. When the shaft 29 is then rotated in a second direction, there is nothing to prevent the cover 34 from rotating with the shaft 29, and so the cover 34 is rotated in that second direction back to the first position.

Rotation of the screw 26 in said first direction to dispense powder from the hopper 20 thus opens the exit aperture 22 automatically, so that powder can be expelled from the exit aperture 22 and into the mixing funnel 56. Once the desired amount of powder has been dispensed, the screw 26 is rotated in the second direction to the first position, so that the exit aperture 22 is closed by the cover 34 and the hopper 20 is sealed. A stop (not shown) is used to prevent the cover 34 moving beyond the first position. In an alternative embodiment (not shown), the stepper motor 30 allows movement of the cover 34 between the first and second positions to be controlled, as the rotational position of the shaft 29 can be controlled by the motor 30.

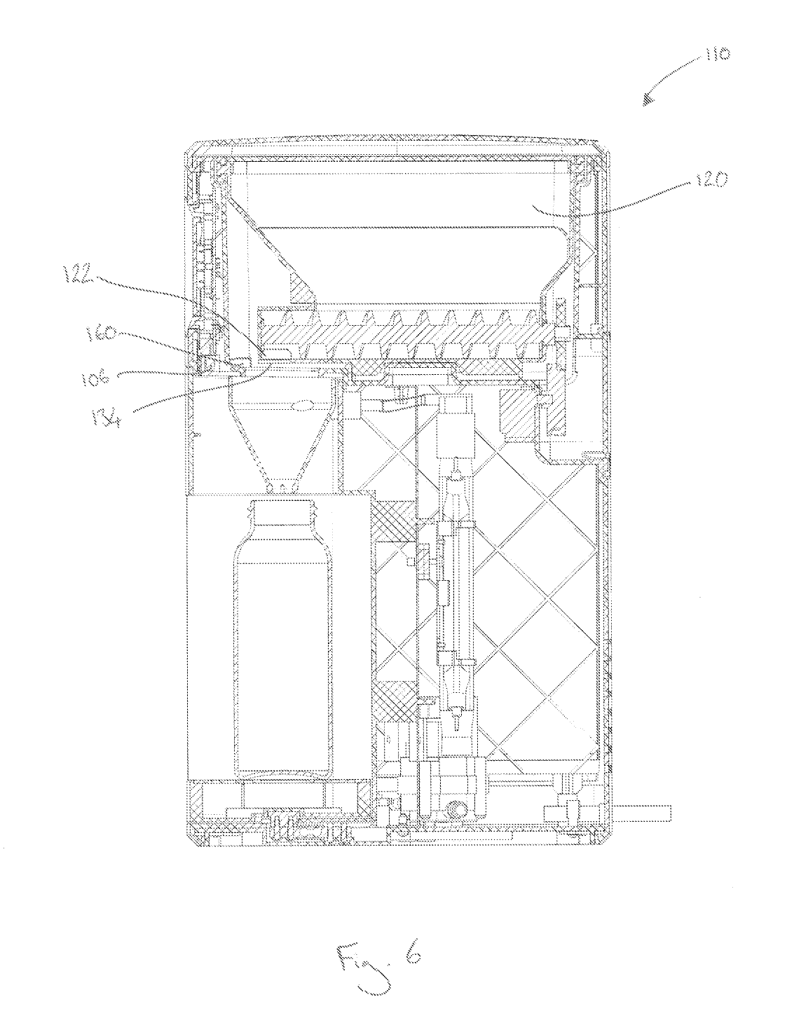

In an alternative embodiment, shown in FIG. 6, features corresponding to those of the previous embodiment have been given corresponding reference numbers with the additional prefix “1”. The cover 134 of this embodiment comprises a plate movable between a first, closed, position and a second, open, position. The cover 134 is shown in the first position in FIG. 6, with the cover 134 over the exit aperture 122 so that the exit aperture 122 is closed and powder is prevented from exiting the hopper 120. When in the second position the cover 134 is away from the exit aperture 122 so that the exit aperture 122 is open and powder can exit the hopper 120 through the aperture 122. The cover 134 is biased towards the first position by a biasing mechanism (not shown) such as a spring. In alternative embodiments the cover 134 may be biased towards the second position.

The cover 134 is moved between the first and second positions by an electromechanical actuator such as, in this embodiment, a solenoid 160. The solenoid 160 is operated by the control system 106. When the cover 134 is to be moved to the second position so that powder can be dispensed, the control system 106 activates the solenoid 106, and a linkage (not shown) moves the cover 134 to the second position. When the cover 134 is to be returned to the first, closed position, the solenoid 160 is deactivated, and the biasing mechanism returns the cover 134 to the first position. In alternative embodiments other electromechanical actuators may be used.

The cover 134 and solenoid 160 of the embodiment shown in FIG. 6 may be used in place of the cover 34 in the embodiment of FIGS. 1 to 5.

With reference to the embodiment of FIGS. 1 to 5, when the hopper 20 contains enough powder to cover the screw 26, the amount of powder dispensed by each turn or proportion of a turn of the screw 26 is known. Controlling the number of turns of the screw 26 is therefore an accurate form of determining the amount of powder dispensed when the hopper 20 contains enough powder.

However, when the level of powder in the hopper 20 falls below the edge of the screw 20, the amount of powder dispensed by turning the screw 26 is not known, and so incorrect amounts of powder could be dispensed. In order to prevent this, the powder dispensing apparatus 12 has a sensor arrangement 41 configured to detect low levels of powder in the hopper 20, as described below.

The screw 26 has a predetermined amount of axial freedom of movement within the hopper 20. Due to the angle at which the bevel gear teeth are provided, rotation of the bevel gear 32 acts to bias the screw 26 towards the end wall 21, i.e. towards the left of the hopper 20 as shown in FIG. 2.

When the hopper 20 contains a predetermined amount of powder (e.g. enough powder to cover the screw 26), the powder provides a reaction force against turning of the screw 26 strong enough to retain the screw 26 at the right of the hopper 20 as shown in FIG. 2 against the bias generated by the gear teeth. However, when there is not enough powder in the hopper 20, the reaction force is not strong enough to retain the screw 26 at the right of the hopper 20. The screw 26 is thus moved by the bevel gear 32 towards the left of the hopper 20.

The sensor arrangement 41 is configured to detect movement of the screw 26 to the left and transmit this information to the control system, so that the control system can prevent further dispensing and/or indicate to the user that the hopper 20 must be refilled. In this embodiment, the sensor arrangement 41 comprises a Hall effect sensor 42 attached to the inside of the housing 16 opposite the first end 29a of the shaft 29, and a permanent magnet 44 attached to the first end 29a.

When the screw 26 is moved towards the left of the hopper 20, the magnet 44 is detected by the sensor 42 as being at a predetermined position, and the sensor 42 indicates to the control system that the screw 26 has moved. The control system then stops dispensing and/or provides an indication in the form of a light or sound, or other alert, that the hopper 20 should be refilled.

In order to accurately indicate when powder levels are too low, it is advantageous that the powder dispensing apparatus 12 be calibrated, preferably by a self calibration routine provided within the control system.

Typically, upon first use, and with an empty hopper 20 and screw 26, the control system 6 operates the motor 30 to rotate the screw 26 so that the screw 26 is moved to the left by the gear 32. This provides a “high” output datum for the sensor 42, so that the control system will recognise when the screw 26 reaches this position again. Drive is then reversed to provide a “low” datum to correspond to a sufficiently full hopper. The control system 6 may in fact store threshold levels slightly below the “high” and above the “low” to ensure reliable future operation. In variants, the control system may be configured to periodically re-run the calibration routine to ensure the datum values remain valid.

In an alternative embodiment (not shown), load on the motor 30 is used to determine powder levels in the hopper 20, rather than using the sensor arrangement 41. The current taken by the motor depends on the reaction force against turning of the screw 26 provided by the powder. That is, the more powder there is in the hopper 20, the greater the reaction force, and so the greater the load on the motor 30 when turning the screw 26. Measurement of the current taken by the motor 30 thus provides an indication of powder levels in the hopper 20. The control system 6 is programmed to prevent further dispensing and/or indicate to the user that the hopper 20 must be refilled when the current taken by the motor 30 falls below a predetermined level.

The liquid dispensing apparatus 14 comprises a reservoir 46 having a temperature sensor 47 for water held therein. The reservoir 46 has a series of indication lines 48 over a transparent portion 50 so that a user can read the volume of water held therein. The liquid dispensing apparatus 14 further comprises an in-line heater 52, a pump 54 and a flow meter 55. The pump 54 is configured to pump water from the reservoir 46 through the heater 52 and flow meter 55, and into the mixing funnel 56 to mix with the powder dispensed thereto. Water enters the mixing funnel 56 through a conduit 58 and passes through the funnel 56 in a vortex before entering the bottle 17. In an alternative embodiment the heater 52 may be gravity fed from the reservoir 46.

It is recommended that water reach the powder at a temperature of at least 70° C., so that the powder is sterilised. The control system 6 detects the ambient temperature of the water in the reservoir and calculates the temperature change required to allow the water to reach, for example, 70° C. Temperature rise is controlled by the length of time water spends passing through the heater 52. The control system 6 dictates to the pump 54 the flow rate required to change the temperature by the desired amount, and the required amount of water is dispensed at, for example, 70° C. into the mixing funnel 56. Water is preferably dispensed at around 75° in order to ensure that it is over the advised threshold of 70°. The flow meter 55 monitors the amount of water dispensed and transmits this information to the control system 6 for increased accuracy.

The powder dispensing apparatus 12 is preferably configured such that the required volume of powder for a given amount of mixed formula is dispensed more rapidly than the required volume of water to dissolve that amount of powder. Thus if the control system is configured such that water and powder are dispensed simultaneously, only a portion of the total volume of liquid required need be dispensed at a high temperature in order to sterilise the powder.

Thus, in operation, the control system 6 signals the following sequence of operations: measurement of the ambient temperature of the water in the reservoir 46, heating of the heater 52, and driving of the pump 54 at a required rate and for the required length of time to achieve the desired high temperature for the required volume of liquid. Substantially simultaneously, the control system 6 signals drive to the motor 30 to dispense the powder and monitors for the set number of revolutions required to dispense the volume of powder required. The selector 18 is operated by the user to indicate to the control system 6 the volume of solution that is required, and the control system 6 adjusts the volume of liquid and amount of powder dispensed accordingly.

The powder meets the heated water in the mixing funnel 56 and the resulting solution will enter the bottle 17. Once the required powder and the first, heated portion of water has been dispensed, the heater 52 is switched off by the control system 6, and the remainder of the water is pumped to the bottle 17 at an ambient temperature, rinsing any powder residue from the funnel 56 as it goes. The powder dissolves in the water in the mixing funnel 56 and/or in the bottle 17. In an alternative embodiment ambient water is pumped to the mixing funnel 56 without passing through the heater. Whilst the powder may be dispensed at a different stage of the water dispensing cycle, it is considered advantageous to do so at or towards the beginning, in order for rinsing to occur afterwards.

In this embodiment approximately a third of the total water required is dispensed at a high temperature, and the remaining two thirds is dispensed at ambient temperature. The high temperature liquid is cooled by the addition of the ambient liquid to a suitable drinking temperature, and so the solution can be fed to a baby with less delay.

The liquid dispensing apparatus 14 can be run on a cleaning cycle, for example by choosing such a cycle with the selector 18. A sodium hypochlorite sterilising tablet such as a Milton® is dissolved in water in the reservoir 46 and heated water is sent through the apparatus 14 for a longer period of time than in a standard cycle. Alternatively, water at an ambient temperature may be used for cleaning.

The present invention provides a dispensing apparatus that can easily be cleaned and is easy to operate. Powder held within the dispenser is kept dry and clean by automatic closing of the dispenser after use. Accurate dispensing of powder is provided by the Archimedes screw and the sensor arrangement. The dispensing arrangement of the present invention minimises the component count and uses simple, easy to assemble and clean arrangements to achieve these results, and so is relatively inexpensive.

In alternative embodiments the powder dispensing arrangement may be provided without a corresponding liquid dispensing arrangement. Other types of sensor may be used in the sensor arrangement. Other types of cover may be used to close the exit aperture. Methods other than the bevel gear may be used to bias the screw 26, such as a spring, or inclining the Archimedes screw downwardly at a suitable angle. A dog clutch or other clutch arrangement may be used between the cover 34 and the shaft 29. Mixing of powder and liquid could take place in the bottle 17 rather than in the funnel 56. Other types of motor may be used to operate the screw 26, with a mechanism for measuring the number of rotations of the screw either through a feedback sensor or control of the motor. Alternative water and powder storage and delivery layouts may be used. The motor 30 may drive a worm wheel that meshes with the bevel gear.

1. A dispensing apparatus for dispensing a controlled amount of powder, the apparatus comprising:
a hopper defining an exit aperture;
an Archimedes screw rotatably supported in the hopper and configured to expel powder from the exit aperture;
an actuator configured to rotate the Archimedes screw;
a cover configured to selectively close the exit aperture; and
a clutch arrangement between the cover and the Archimedes screw;
wherein movement of the cover is controlled by the Archimedes screw through the clutch arrangement.

2. A dispensing apparatus according to claim 1 wherein the clutch arrangement is configured to retain the cover in frictional engagement with the Archimedes screw, such that the cover is rotatable with the Archimedes screw.

3. A dispensing apparatus according to claim 2 comprising a stop configured for engagement with the cover so as to inhibit rotation of the cover with the Archimedes screw when the cover is engaged with the stop.

4. A dispensing apparatus according to claim 1 wherein the cover is configured to open the exit aperture upon rotation of the Archimedes screw in a first direction.

5. A dispensing apparatus according to claim 1 wherein the cover is configured to close the exit aperture upon rotation of the Archimedes screw in a second direction.

6. A dispensing apparatus according to claim 1 wherein the clutch arrangement comprises a resilient member arranged to retain the cover in frictional engagement with the Archimedes screw.

7. A dispensing apparatus according to claim 6 wherein the resilient member comprises a conical spring attached to the Archimedes screw.

8. A dispensing apparatus according to claim 1 further comprising a detection arrangement configured to determine loading of the Archimedes screw.

9. A dispensing apparatus according to claim 8 wherein the Archimedes screw is axially movable in relation to the hopper, and wherein the detection arrangement comprises a biasing mechanism configured to bias the Archimedes screw in a first axial direction opposing a reaction force induced by powder acting against rotation of the Archimedes screw, and a sensor arrangement configured to detect movement of the Archimedes screw in said first axial direction.

10. A dispensing apparatus according to claim 8 wherein the actuator is a motor and the detection arrangement comprises said motor and a control system, and wherein the control system is configured to monitor current taken by the motor.

11. A dispensing apparatus according to claim 1 for dispensing a controlled amount of powder and a controlled volume of liquid, the apparatus further comprising:
a liquid supply;
a heater in fluid communication with the supply;
a transfer arrangement for transferring liquid from the supply; and
a control system configured to control the liquid temperature;
wherein the control system is configured to dispense a first volume of liquid at a first, higher than ambient temperature and a second volume of liquid at a second temperature lower than the first temperature, through selective operation of the transfer arrangement and/or the heater, and wherein the first volume of liquid is mixed with said controlled amount of powder.

12. A dispensing apparatus according to claim 11 wherein the control system is configured to dispense the first volume of liquid prior to dispensing of the second volume of liquid.

13. A dispensing apparatus for dispensing a controlled amount of powder, the apparatus comprising:
a hopper defining an exit aperture;
an Archimedes screw rotatably supported in the hopper and configured to expel powder from the exit aperture;
an actuator configured to rotate the Archimedes screw; and
a detection arrangement configured to determine loading of the Archimedes screw.

14. A dispensing arrangement according to claim 13 wherein the Archimedes screw is axially movable in relation to the hopper, and wherein the detection arrangement comprises a biasing mechanism configured to bias the Archimedes screw in a first axial direction opposing a reaction force induced by powder acting against rotation of the Archimedes screw, and a sensor arrangement configured to detect movement of the Archimedes screw in said first axial direction, preferably wherein the sensor arrangement comprises a Hall effect sensor.

15. A dispensing apparatus to according to claim 13 wherein the biasing mechanism comprises a bevel gear arranged operationally between the actuator and the Archimedes screw.

16. A dispensing apparatus according to claim 13 wherein the actuator is a motor and the detection arrangement comprises said motor and a control system, and wherein the control system is configured to monitor current taken by the motor.

17. A dispensing apparatus for dispensing a controlled volume of liquid, the apparatus comprising:
a liquid supply;
a heater in fluid communication with the supply;
a transfer arrangement for transferring liquid from the supply; and
a control system configured to control the liquid temperature;
wherein the control system is configured to dispense a first volume of liquid at a first, higher than ambient temperature and a second volume of liquid at a second temperature lower than the first temperature, through selective operation of the transfer arrangement and/or the heater.

18. A dispensing apparatus according to claim 17 wherein the control system is configured to dispense the first volume of liquid prior to dispensing of the second volume of liquid.

19. A dispensing apparatus according to claim 17 wherein the transfer arrangement is a pump.

20. A dispensing apparatus according to claim 17 wherein the first temperature is at least 70° C.
